(19) United States
(12) Patent Application Publication
(10) Pub. No.: US 2014/0272830 A1
(43) Pub. Date: Sep. 18, 2014

(54) SYSTEM AND METHOD FOR PROFESSIONAL EDUCATION

(71) Applicant: Omar Taher, Los Angeles, CA (US)

(72) Inventor: Omar Taher, Los Angeles, CA (US)

(21) Appl. No.: 13/714,397

(22) Filed: Mar. 16, 2013

(51) Int. Cl. G09B 5/08

(52) U.S. Cl. CPC G09B 5/08
USPC 434/219

(57) ABSTRACT

A system and method for professional education through a business system of cooperating participants and other educational service providers, organized in order to effect incentive-based individual learning: namely, to engage the user as a learner by way of offering participation incentives. The associated educational service pertains to individualized programs for licensure or certification in the fields of medicine, dentistry, law, or business, depending on the individual learner's needs. The system and method thus provides incentive opportunities as further motivation to learn, without exclusively providing monetary gain to the learner although monetary gain is an option. The learner derives benefit from the knowledge gained in preparation for license or certification examinations, and from the goodwill of his or her efforts resulting in some benefit bestowed upon others.

### CROSS-REFERENCE TO RELATED APPLICATIONS

Application No. 61/570,471, EFS ID 11616630, filed 14 Dec. 2011

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

The present innovation is in the technical field of professional education. More particularly, the present innovation is in the technical field of incentive-based professional education, with benefit directly to the individual learner, and benefits that may be bestowed to others.

All learned professions, such as medicine, dentistry, and law, are founded upon formal education, diligent practice applied over many years, licensure, certification, standards of practice, and continuing education across the entire professional career. Missteps may derail a career early on as well as years later. The loss of time and money invested in perusing a learned profession may be personally devastating if the required licenses and certifications are denied or revoked.

For example, the road to being a licensed medical or osteopathic doctor in the United States takes on the order of 7 to 8 years or more of formal education beyond high school. This includes 3 or more years college or university (some states do not require graduation) and 3 or more years of medical school. It is not uncommon for medical students to take a year off from study. After graduation from medical school come periods of practice internship and residency which, when combined, may add 3 to 8 years or more to the journey.

Consider the medical profession further. It is not uncommon for a person to be overwhelmed by the pace, volume, and exposure duration of the information needed to succeed. Furthermore, the physical, mental, and financial stresses along the way, as well as external pressures from family, friends, and spouses, and significant others, may wreak havoc on the individual and cause the individual to leave before completion. Sometimes those who fall along the way are left with huge debt to repay, which further restricts their survival in careers other than the path originally chosen. Time and youth may be lost, and opportunities irrecoverably forgone in an effort that could not be completed. It is reasonable to imagine that individuals who would have otherwise been excellent medical practitioners were left by the wayside as one or more of the pressures and stresses proved to be too much for the particular individual's circumstances.

All learned professions have aspects such as these, to differing degrees.

Considering again the medical profession, as if the barriers mentioned above were not enough, one or two more mountains lie ahead after graduation: licensure and certification. For medical doctors, we have the United States Medial Examinations (“USMLE”), comprising 3 enumerated “Steps.” For osteopathic doctors, we have the Comprehensive Osteopathic Licensing Examination (“COMLEX”), comprising 4 enumerated “Levels.” Each state may have additional requirements, and the states may or may not have reciprocity arrangements in place.

Board certification is the possible second mountain, if the practitioner chooses to pursue it. This requires perhaps up to 7 years or more of residency, depending upon the specialty. Another examination awaits after that.

For all learned professional that require years of formal education, years of practice, licensure, and certification, the journey itself provides sufficient exposure to what is required to pass examination. Yet the examinations are somewhat artificial environments. The practitioner must be able to spot the issue in the examination questions, respond in the prescribed format and limitations, and organize thinking in the context of the examination environment as opposed to the real world.” An entire industry exists for selling professional examination preparation materials and courses.

Those who survive prior to examinations, who have handled the personal, professional, physical, and mental challenges, often need support and encouragement to continue. This can come from friends, family, and other students. It can come from vendors seeking goodwill that may turn into profit after the candidate succeeds. Financial pressures may very well still be there, which would limit what the individual may be able to pay for study materials and courses. Also, as many entered the profession seeking to do good for the benefit of others, by now their singular concentrated work has likely provided little opportunity for that.

What the professional education industry and system lack is of incentive-based professional education, at little or no cost to the learner, with incentives both for participation and in achievement. Benefits to the learner include both learning that enhances the prospects of passing the licensure and certification examinations, and value that can be converted to money or discounts. Furthermore, benefit may flow directly to the individual learner, or may be bestowed to others: to other learners or charities. The result would be a business and societal ecosystem, wherein benefits arise and flow for the general good of all.

### SUMMARY

We disclose a system and method comprising a rule-based business ecosystem for incentive-based professional learning, further comprising a cooperative relationship among learners, their friends, their family members, learning system coordinators, sponsors, advertisers, investors (who profit and provide capital), charities, and business partners in a mutually beneficial business ecosystem with the primary goal of assisting the learner to pass certification examinations. The incentives are variable, based on available funds, content to be delivered, learner participation, and learner achievement.

The intended use is as an educational service in association with other educational services in order to effect incentive-based individual learning: namely, to engage the user as a learner by way of offering participation incentives. The larger, associated educational service pertains to individualized programs for licensure or certification in the fields of medicine, dentistry, law, or business, depending on the individual learner's needs. The incentives provided through the system and method comprise points earned which may then be redeemed according to the learner's specific desires. Redemption options include money prizes to the learner with taxable income consequences, but also include credits or scholarships for further learning, monetary donations to charitable entities, and alternative incentives that are delivered in such ways so as specifically not to create income recognition consequences for the learner. Even if the learner chooses money, the system and method, through a conversion calculation, will make charitable contributions that match the points earned.

Fields of use include licensed professional education, such as for physicians, lawyers, engineers, and other professions, as well as non-licensed proficiency certification, such as language, technology, and para-professional fields.

The system and method thus provides incentive opportunities as further motivation to learn, without exclusively providing monetary gain to the learner (although monetary gain is an option). The learner derives benefit from the knowledge gained in preparation for license or certification examinations, and from the goodwill of his or her efforts resulting in some benefit bestowed upon others.

### BRIEF DESCRIPTION OF THE DRAWINGS

FIG. 1 shows an overview of the incentive learning system, the participants, and the flow of information and value among them;

FIG. 2 shows an expanded view of the incentive learning system, with a learning management system at its core;

FIG. 3 shows the learning environments of several learners linked, for communication, encouragement, and transactions;

FIG. 4 shows an initial screen that prompt the learner for access credentials, required or the learner to log in;

FIG. 5 shows a dashboard, individualized for the particular learner, that is visible after successful login;

FIG. 6 shows a chat operation, individualized for the particular learner, that is visible after successful login;

FIG. 7 shows a learn to earn session, individualized for the particular learner, that is visible after successful login;

FIG. 8 shows a quiz operation, individualized for the particular learner, that is visible after successful login;

FIG. 9 shows access to an inbox, individualized for the particular learner, that is visible after successful login;

FIG. 10 shows a learn to give session, individualized for the particular learner, that is visible after successful login;

FIG. 11 shows a lounge session, individualized for the particular learner, that is visible after successful login;

FIG. 12 shows market access session where learners may buy products and services from vendors, individualized for the particular learner, that is visible after successful login;

### DETAILED DESCRIPTION

### Reference Numerals

14 Learner
15 Incentive learning system
16 External participant
17 Learner communication
18 Learner communication channel
19 coordinator communication
20 External participant communication
102 Coordinator
104 Investor
106 Other financing source
108 Accredited content provider
110 Charity
112 Vendor
114 Sponsored content provider
116 Accredited content
120 Accredited content channel
122 Sponsored content channel
124 Sponsored content
126 Internet
128 Internet accessible device
30 Smart phone
32 Computer system
40 User experience engine
50 Learning management engine
502 Learning management system
504 Sponsored content database
506 Accredited content database
508 Learner profile database
60 Charity payout engine
61 Charity payout channel
62 Reward redemption engine
64 Vendor channel
66 Sponsored content provider engine
70 Accredited content provider engine
80 Money account repository
82 Discount repository
84 Social point repository
86 Smart point repository
90 Incentive learning system instantiation
92 Banner advertisement

Referring now to the innovation in more detail, FIG. 1 presents various external participant 16 that connect to incentive learning system 15, and shows flows of information or value between and among them. External participant 16 include accredited content provider 108, sponsored content provider 114, charity 110, vendor 112, investor 104, and other financing source 106.

FIG. 1 depicts the general flow of incentives, benefits, and instructions between and among incentive learning system 15, learner 14, coordinator 102, and external participant 16. Rewards flow from external participant 16 to learner 14. Through incentive learning system 15, learner 14 contributes participation, and in return receives knowledge and rewards. Learner 14 also may communicate with other learner 14. Learner 14 gives direction to incentive learning system 15 as to reward redemption and money to be given to charity 110.

Accredited content provider 108 present accredited content 116 to incentive learning system 15. Accredited content 116 refers to material that is directly designed to prepare learner 14 to take and pass certain professional examinations. Accredited content 116 meets certain criteria of an appropriate certifying agency, and covers knowledge that learner 14 must demonstrate successfully through accreditation examinations.

Sponsored content provider 114 also deliver sponsored content 124 and, in exchange, receive marketing access to learner 14. Such access may include direct information about learner 14, or merely exposure through advertising that accompanies sponsored content. Sponsored content 124 is important and useful information, but not necessarily designed to help learner 14 in regard to professional examinations.

Incentive learning system 15 is directed, managed, or steered by coordinator 102 who operates according to business rules and information in and through the incentive learning system. Coordinator 102 has access to information in the aggregate and per individual learner 14 such as available funds for rewards, learner 14 participation, learner 14 achievement, vendor 112 inquiries, recommendations of charity 110, and other information. Coordinator 102 may then control criteria for rewards, limits of awards, formulas for rewards, and formulas for pay out to charity 110.

FIG. 2 shows incentive learning system 15 in greater detail, where a means for connection is via Internet 126, by way of example. Learner 14 has use of an internet accessible device 128, which may be a so-called smart phone 30 or a computer system. Learner 14 has access to internet 126 through internet 126 accessible device. In turn, through Internet 126 and internet 126 accessible device 128, learner 14 has access to incentive learning system 15. A user experience engine 40 is a layer between Internet 126 and learner 14, for receiving and transmitting information, requests, and responses between learner 14 and incentive learning system 15. The communication path thus is from learner 14, through internet accessible device 128, through internet 126, through user experience engine 40, and to incentive learning system 15.

Communication between external participants 16 to incentive learning system 15 takes place through a particular corresponding channel: accredited content provider 108 communicates through accredited content channel 120, charity 110 communicates through charity payout channel 64, vendor 112 communicates through vendor channel 64, and sponsored content provider 114 communicates through sponsored content channel 122.

Furthermore, just as internet 126 or other network medium is the communications medium between learner 14 and incentive learning system 15, internet 126 or other network medium is also the means for incentive learning system 15 to communicate to other external participant 16.

In FIG. 2, internet 126 is depicted as an outer layer for communications to external systems and an inner layer for communications with learner.

FIG. 2 shows a learning management engine 50 at the core of incentive learning system 15, further comprising a learning management system 502, a sponsored content database 504, an accredited content database 506, and a learner profile database 508.

An accredited content provider channel 22 provides the means for communication, through internet 126, with accredited content provider 108. Accredited content channel 22 manages that relationship and properly delivers accredited content 116 to learning management system 502 and the associated accredited content database 506.

The learning management system 502 is the means for delivering and managing both accredited content 116 and sponsored content 124, as well as tracking learner 14 learning progress and needs. Learner profile database 508 contains specific information about each learner 14 and holds records of progress and other information associated with learning. The sponsored content database 504 holds learning content that comes from sponsored content provider 114. Similarly, accredited content database 506 holds learning content provided by accredited content provider 108.

Surrounding learning management system 502 are accredited content channel 120, learner communication channel 18, charity payout engine 60, reward redemption engine 62, vendor channel 64, and sponsored content channel 122.

Learner communication channel 18 provides a means for each learner 14 to communicate with any other learner 14 who is using incentive learning system 15.

The charity payout engine 60 provides a means for delivering money to any particular charitable agencies that learner 14 has designated as a recipient. Because charity 110 is an external participant 16, charity payout engine 60 communicates through a network means, such as internet 126.

FIG. 2 also depicts reward redemption engine 62 having several subcomponents to address various kinds of rewards that are available to learner. These subcomponents include a money account repository 80, a discount repository 82, a social point repository 84, and a smart point repository 86. Each particular subcomponent contains information for that learner 14 with respect to a particular reward. Such information includes amount available, how distributed, when distributed, history, and similar information.

Vendor channel 64 manages interfaces between incentive learning system 15 and vendor 112 who have access to learner 14 for marketing of products and services. Because the vendors are also external participant 16, the medium for communications is as a network means, such as internet 126.

Sponsored content channel 122 provides means for communication between incentive learning system 15 and sponsored content provider 114. Sponsored content provider 114 makes available learning content that is of a general nature and not necessarily for use in preparation for certain accreditation examinations. Sponsored content channel 122 manages that relationship and properly delivers sponsored content to learning management system 502 and associated sponsored content database 504.

In one embodiment, learner 14 receives points for participation and for performance on quizzes. The value of points is determined by business rules, and established by coordinator 102. After achieving a certain number of points, which is also determined by rule and established by coordinator 102, learner 14 is eligible for rewards. However, no reward is guaranteed. Again, rules determine which of several learner 14 who have achieved a certain number of points are winners. The financial state of incentive learning system 15 and rule determine the amount of the reward. Coordinator 102 monitors and manages incentive learning system 15 according to available funds for rewards and operational costs.

In another embodiment, as well, rules as enforced by coordinator 102 may decide payout amounts to charity 110 regardless of, but also in combination with, donations by learner 14 of learner 14 rewards to charity 110.

FIG. 3 depicts the notion of several incentive learning system 15 instances, where each learner 14 is in effect in an individual bubble with respect to that learner 14's experiences through incentive learning system 15. However, each learner 14 has a means for communication with each other learner 14 through learner communication channel 18, and thus may encourage each other in learning efforts, donate points or rewards, and otherwise share experiences as each may so chose. By way of example, FIG. 3 shows a first and a second incentive learning system instantiation 90, each of which is connected to the other through a learner communication channel 18 that in turn is connected to learner communication channel 18 for each incentive learning system instantiation 90.

In another embodiment, friends and family members may be external participants 10 to communicate and encourage learner 14, and may participate in buying vendor 112 products and services.

Turning now to what each learner 14 may see as presented by user experience engine 40, FIGS. 4 through 12 show various screen representations. On all such screens banner advertisement 92 may appears and give learner 14 an opportunity to contact vendor 112.

FIG. 5 is a screen that is presented upon login, and shows progress information for the particular learner 14 based on information the learner profile database 508 and accredited content 116 undertaken.

FIG. 6 shows an implementation of communication between and among several learner 14, such communication shown here as a chat session.

FIG. 6 shows a screen with the following operations: enrollment, login, preview, review of colleague achievements, friend and family support engagement, and mode. Sessions cover activities of learning, earning rewards, and giving.

FIG. 7 shows a “learn to earn” session that is visible after login and after selection of a “learn to earn” mode. It shows a means for engaging quizzes on accredited content 116, and acquiring points. Points are earned for participation as well as for success.

FIG. 8 shows a screen for a typical quiz question, from the “learn to earn” mode of operation. The quiz is indentified as well as the elapsed time.

FIG. 9 shows another implementation of communication between and among learner 14, shown here as an electronic mail implementation.

FIG. 10 shows an implementation of a screen that supports the learn to give mode. It presents banners and other presentations about candidate charity 110 that learner 14 may select as recipient of money earned through participation incentive learning system 15.

FIG. 11 shows an implementation of a lounge, here depicted as a doctors' lounge, where learner 14 may engage in sponsored learning activities, explore vendor 112 product and services offerings, and engage in social activities such as responding to polls.

FIG. 12 shows a screen intended primarily for exploring vendor 112 products and services offerings. It includes information about money and discount account balances, the money and discounts being available to apply to purchase of vendor 112 products and services.

The advantages of incentive learning system 15 include, without limitation, a means for using incentives to encourage participation and learning, in a system that returns value to learner 14, vendor 112, friends, family, investor 104, and charity 110.

In broad embodiment, the present innovation is a system and method for education in various categories or communities of learner 14, where incentives for learning and participation may be varied by rule and based on feedback information from incentive learning system 15, where each learner 14 may donate rewards to charity 110 or to another learner 14, and where friends, family, and others may communicate encouragement to any learner 14.

While the foregoing written description of the innovation enables one of ordinary skill to make and use what is considered presently to be the best mode thereof, those of ordinary skill will understand and appreciate the existence of variations, combinations, and equivalents of the specific embodiment, method, and examples herein. The innovation should therefore not be limited by the above described embodiment, method, and examples, but by all embodiments and methods within the scope and spirit of the innovation.

I claim:

1. An incentive learning system for professional education comprising a plurality of learners;
a coordinator to manage the incentive learning system;
a plurality of non-learners, where each such non-learner may provide individual encouragement to the plurality of learners;
sponsored content;
accredited content;
a plurality of vendors who receive marketing access to plurality of learners;
a plurality of charities;
incentives, the incentives further comprising rewards, where the rewards include smart points for achievement on accredited content, social points for participation, the smart points and social points being convertible to redeemable monetary value;
the incentives further comprising means for the learners give the monetary value to charities or to other learners in the incentive learning system;
a learning management system for delivery of accredited content and sponsored content, the learning management system further providing means for tracking individual progress of the plurality of learners;
communication means among the plurality of learners, the plurality of non-learners, and the coordinator;
and means for tracking earning and redemption of rewards.

2. A method for providing incentive-based professional education comprising:
presenting accredited content to a plurality of learners;
presenting sponsored content to a plurality of learners;
allowing vendors marketing access to learners;
allowing the plurality of learners to earn redeemable points for achievement and for participation, where the redeemable points have monetary value;
tracking the earning and redemption of the redeemable points;
allowing the plurality of learners to give redeemable points of monetary value to others, where the others further comprise other individuals of the plurality of learners or charities learners;
tracking individual progress and achievement of the plurality of learners;
and allowing non-learners to provide individual encouragement to the plurality of learners.
